(19) United States
(12) Patent Application Publication
(10) Pub. No.: US 2019/0207501 A1
(43) Pub. Date: Jul. 4, 2019

(54) MOVER, VIBRATION ACTUATOR, AND ELECTRONIC DEVICE

(71) Applicant: ALPS ALPINE CO., LTD., Tokyo (JP)

(72) Inventor: Katsutoshi SUZUKI, Miyagi (JP)

(21) Appl. No.: 16/295,307

(22) Filed: Mar. 7, 2019

Related U.S. Application Data
(63) Continuation of application No. PCT/JP2017/032520, filed on Sep. 8, 2017.

(30) Foreign Application Priority Data
Sep. 13, 2016 (JP) 2016-178205

(51) Int. Cl. H02K 33/18; B06B 1/04

(52) U.S. Cl. CPC H02K 33/18; B06B 1/045

(57) ABSTRACT

A mover for a vibration actuator is provided. The mover includes a substrate, a permanent magnet that is embedded in the substrate, a weight plate disposed on one surface of the substrate, and another weight plate disposed on another surface of the substrate, wherein the weight plates are disposed on the substrate at positions that do not overlap the permanent magnet.

### CROSS-REFERENCE TO RELATED APPLICATIONS

This application is a continuation of International Application No. PCT/JP2017/032520 filed on Sep. 8, 2017 and designating the U.S., which claims priority to Japanese Patent Application No. 2016-178205 filed on Sep. 13, 2016. The contents of these applications are incorporated herein by reference in their entirety.

### BACKGROUND OF THE INVENTION

### 1. Field of the Invention

The disclosures herein generally relate to a mover, a vibration actuator, and an electronic device.

### 2. Description of the Related Art

Vibration actuators that are mounted on electronic devices such as personal digital assistant or game console controllers, and that vibrate in accordance with users' various operations have been put to practical use.

As such a vibration actuator, a vibration generator including a mover and a plurality of coils is known. The mover includes a magnet and is supported in a displaceable manner with respect to a frame, and the coils generate magnetic fields that cause displacement of the mover (see Patent Document 1, for example).

In recent years, with electronic devices becoming thinner, the demand for making vibration actuators mounted on such electronic device thinner has been increasing. In order to make a vibration actuator thinner, making each component such as a mover thinner can be conceived. However, when the mover is made thinner, the weight of the mover is reduced. Thus, even when the mover vibrates, it becomes difficult to sufficiently provide a vibration sensation to the user of an electronic device.

### RELATED-ART DOCUMENTS

### Patent Documents

[Patent Document 1] Japanese Laid-Open Patent Publication No. 2013-154290

### SUMMARY OF THE INVENTION

It is a general object of one aspect of the present invention to provide a mover of reduced thickness while still having sufficient weight to transmit vibrations.

According to at least one embodiment, a mover for a vibration actuator is provided. The mover includes a substrate, a permanent magnet that is embedded in the substrate, and a weight plate disposed on the substrate.

Other objects and further features of the present invention will be apparent from the following detailed description when read in conjunction with the accompanying drawings.

### BRIEF DESCRIPTION OF THE DRAWINGS

FIG. 1 is a perspective view of a vibration actuator according to an embodiment;

FIG. 2 is a top view of the vibration actuator according to the embodiment;

FIG. 3 is an exploded perspective view of the vibration actuator according to the embodiment;

FIG. 4 is an exploded perspective view of an upper case according to the embodiment;

FIG. 5 is an exploded perspective view of a lower case according to the embodiment;

FIG. 6 is an exploded perspective view of a mover according to the embodiment;

FIG. 7 is a top view of the mover according to the embodiment;

FIG. 8 is a bottom view of the mover according to the embodiment;

FIG. 9 is a cross-sectional view of the mover taken through B-B of FIG. 7;

FIG. 10 is across-sectional view of the mover taken through A-A of FIG. 2;

FIG. 11 is a diagram illustrating the movement of the mover in the X1 direction according to the embodiment;

FIG. 12 is a diagram illustrating the movement of the mover in the Y1 direction according to the embodiment;

FIG. 13 is a diagram illustrating rotation of the mover according to the embodiment;

FIG. 14 is a diagram illustrating a movable range of the mover according to the embodiment;

FIG. 15 is a perspective view of a mobile phone according to the present embodiment;

FIG. 16 is a diagram illustrating a first variation of the mover according to the embodiment;

FIG. 17 is a diagram illustrating a second variation of the mover according to the embodiment; and

FIG. 18 is a diagram illustrating a third variation of the mover according to the embodiment.

### DESCRIPTION OF THE PREFERRED EMBODIMENTS

According to at least one embodiment, a mover of reduced thickness while still having sufficient weight to transmit vibrations is provided.

In the following, embodiments of the present invention will be described with reference to the accompanying drawings. In the drawings, the same elements are denoted by the same reference numerals, and a duplicate description thereof may be omitted.

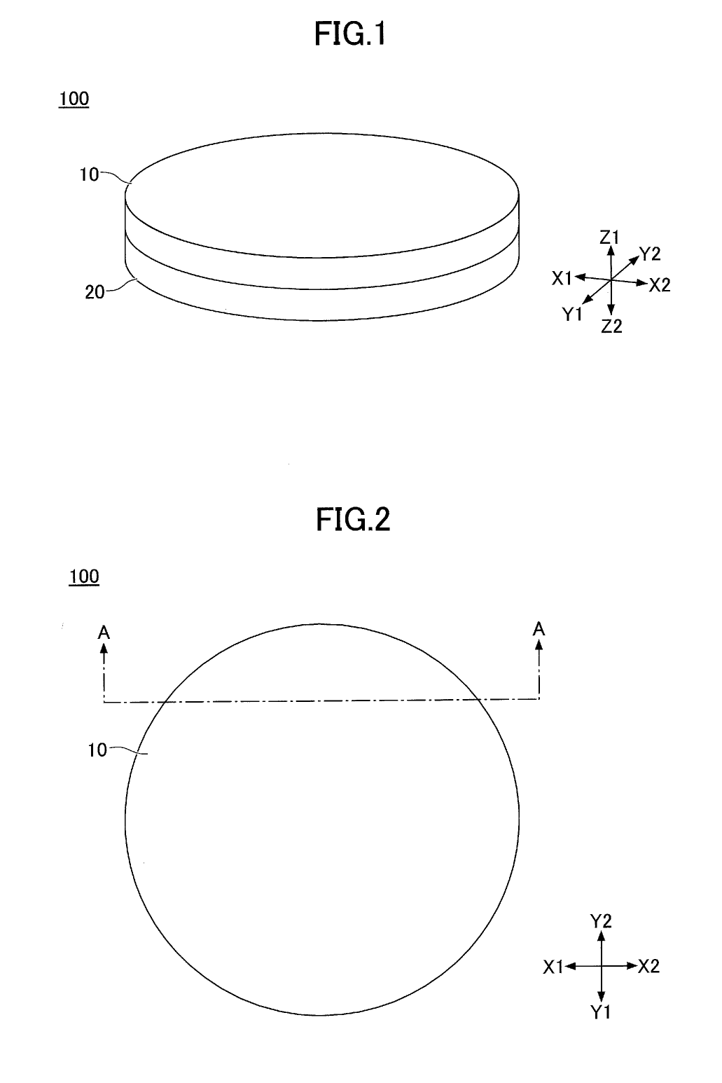

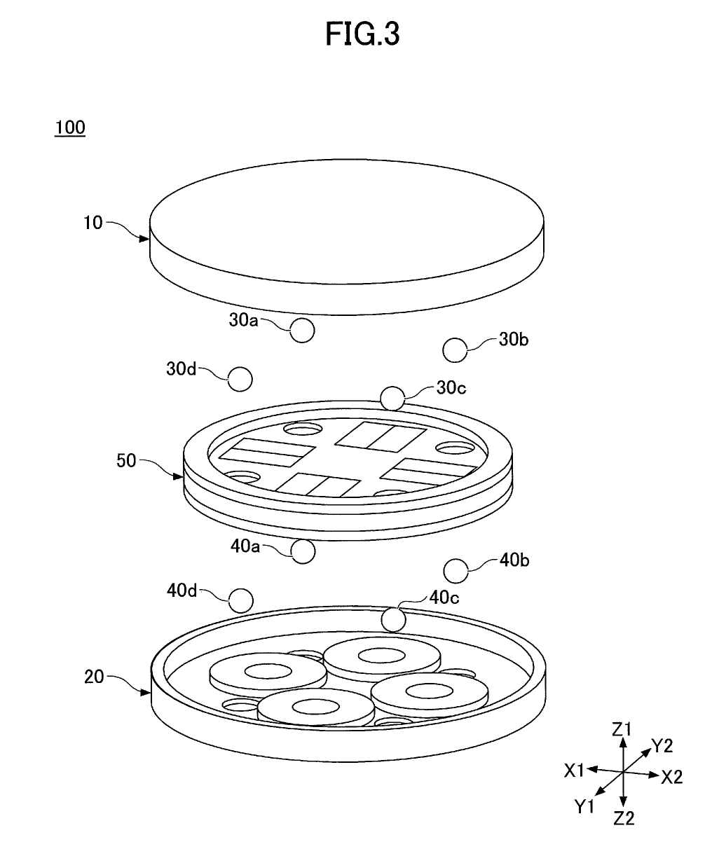

FIG. 1 is a perspective view of a vibration actuator 100 according to an embodiment. FIG. 2 is a top view of the vibration actuator 100 according to the embodiment. FIG. 3 is an exploded perspective view of the vibration actuator 100 according to the embodiment.

In the drawings, the X1X2 direction is a width direction of the vibration actuator 100, the Y1Y2 direction is a depth direction of the vibration actuator 100, and the Z1Z2 direction is a height direction of the vibration actuator 100. Also, in the following, an example may be described with the Z1 direction indicating an upper side and the Z2 direction indicating a lower side; however, the installation orientation of the vibration actuator 100 is not limited thereto.

As illustrated in FIG. 1 through FIG. 3, the vibration actuator 100 includes an upper case 10 and a lower case 20. Further, as illustrated in FIG. 3, the vibration actuator 100 includes a mover 50 housed between the upper case 10 and the lower case 20.

The upper case 10 and the lower case 20 are each formed in a circular shape with the same diameter, and are connected to each other so as to form a case that houses the mover 50 and that functions as a stator of the mover 50 in the vibration actuator 100.

The mover 50 is formed in a disc shape, and is housed between the upper case 10 and the lower case 20. The mover 50 is supported by upper balls 30a through 30d and lower balls 40a through 40d, in such a manner that the mover 50 is movable between the upper case 10 and the lower case 20. In the following description, the same elements may be collectively described as one element by omitting reference numerals a through d.

In the following, the components of the vibration actuator 100 will be described in detail.

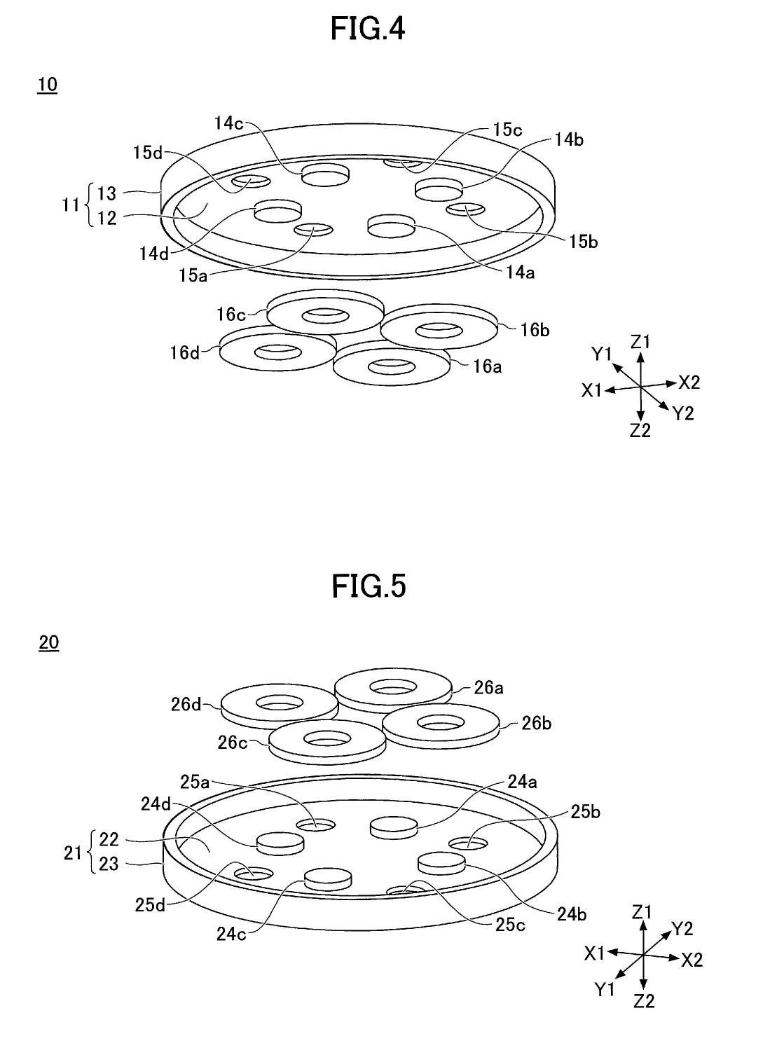

FIG. 4 is an exploded perspective view of the upper case 10 according to the embodiment. As illustrated in FIG. 4, the upper case 10 includes an upper case body 11 and upper coils 16a through 16d.

The upper case body 11 is formed by cutting a magnetic material such as soft iron, ferritic stainless steel, or martensitic stainless steel. The upper case body 11 includes a top plate 12 and an upper side wall 13. The top plate 12 is formed in a circular shape. The top plate 12 may have, for example, a diameter of 20 mm and a thickness of 0.5 mm. The upper side wall 13 is formed so as to protrude from the outer periphery of the top plate 12 in the Z2 direction. The upper side wall 13 has, for example, a height of 1 mm from the lower surface of the top plate 12, and a thickness of 0.5 mm.

Upper cores 14a through 14d and upper case recesses 15a through 15d are formed at the lower surface side of the top plate 12 of the upper case body 11.

The upper cores 14a through 14d protrude from the lower surface of the top plate 12 in the Z2 direction. The upper cores 14a through 14d are located at equal distances from the center of the top plate 12 of the upper case body 11 in the radial direction, and are arranged at equal intervals in the circumferential direction. Further, the upper core 14a and the upper core 14c are arranged parallel to the Y1Y2 direction, and the upper core 14b and the upper core 14d are arranged parallel to the X1X2 direction. The upper cores 14a through 14d may each have, for example, a diameter of 2.3 mm, and a height of 0.5 mm from the lower surface of the top plate 12.

The upper case recesses 15a through 15d are each formed in a circular shape and are recessed in the Z1 direction. The upper case recesses 15a through 15d are located at equal distances from the center of the top plate 12 of the upper case body 11 in the radial direction, and are arranged at equal intervals in the circumferential direction. Further, the upper cores 14a through 14d and the upper case recesses 15a through 15d are alternately arranged on the top plate 12 in the circumferential direction. The upper case recesses 15a through 15d each have a diameter of 1.5 mm, and a depth of 0.3 mm from the lower surface of the top plate 12.

The upper coils 16a through 16d are formed by winding wires, and are attached to the respective upper cores 14a through 14d of the upper case body 11. For example, each end of the wire forming the corresponding upper coil is connected to a driving circuit, and a predetermined amount of current is applied to the upper coil in a predetermined direction.

In the present embodiment, the upper cores 14a through 14d are formed integrally with the top plate 12 of the upper case body 11. However, the upper cores 14a through 14d may be formed separately from the top plate 12. In this case, the upper cores 14a through 14d formed of magnetic materials may be fixed to the upper case 10 that is formed by a drawing process.

FIG. 5 is an exploded perspective view of the lower case 20 according to the embodiment. As illustrated in FIG. 5, the lower case 20 includes a lower case body 21 and lower coils 26a through 26d. The lower case body 21 is formed by cutting a magnetic material such as soft iron, ferritic stainless steel, or martensitic stainless steel. The lower case body 21 includes a base plate 22 and a lower side wall 23. The base plate 22 is formed in a circular shape. The base plate 22 has, for example, a diameter of 20 mm and a thickness of 0.5 mm. The lower side wall 23 is formed so as to protrude from the outer periphery of the base plate 22 in the Z1 direction. The lower side wall 23 has, for example, a height of 1 mm from the upper surface of the base plate 22, and a thickness of 0.5 mm.

Lower cores 24a through 24d and lower case recesses 25a through 25d are formed at an upper surface side of the base plate 22 of the lower case body 21.

The lower cores 24a through 24d are formed so as to protrude from the upper surface of the base plate 22 in the Z1 direction. The lower cores 24a through 24d are located at equal distances from the center of the base plate 22 of the lower case body in the radial direction, and are arranged at equal intervals in the circumferential direction. Further, the lower core 24a and the lower core 24c are arranged parallel to the Y1Y2 direction, and the lower core 24b and the lower core 24d are arranged parallel to the X1X2 direction. The lower cores 24a through 24d may each have, for example, a diameter of 2.3 mm, and a height of 0.5 mm from the upper surface of the base plate 22.

The lower case recesses 25a through 25d are each formed in a circular shape and are recessed in the Z2 direction. The lower case recesses 25a through 25d are located at equal distances from the center of the base plate 22 of the lower case body in the radial direction, and are arranged at equal intervals in the circumferential direction. Further, the lower cores 24a through 24d and the lower case recesses 25a through 25d are alternately arranged on the base plate 22 in the circumferential direction. The lower case recesses 25a through 25d each have a diameter of 1.5 mm, and a depth of 0.3 mm from the upper surface of the base plate 22.

The lower coils 26a through 26d are formed by winding wires, and are attached to the respective lower cores 24a through 24d of the lower case body 21. For example, each end of the wire forming the corresponding lower coil is connected to a driving circuit, and a predetermined amount of current is applied to the lower coil in a predetermined direction.

In the present embodiment, the lower cores 24a through 24d are formed integrally with the base plate 22 of the lower case body 21. However, the lower cores 24a through 24d may be formed separately from the base plate 22. In this case, the lower cores 24a through 24d formed of magnetic materials may be fixed to the lower case 20 that is formed by a drawing process.

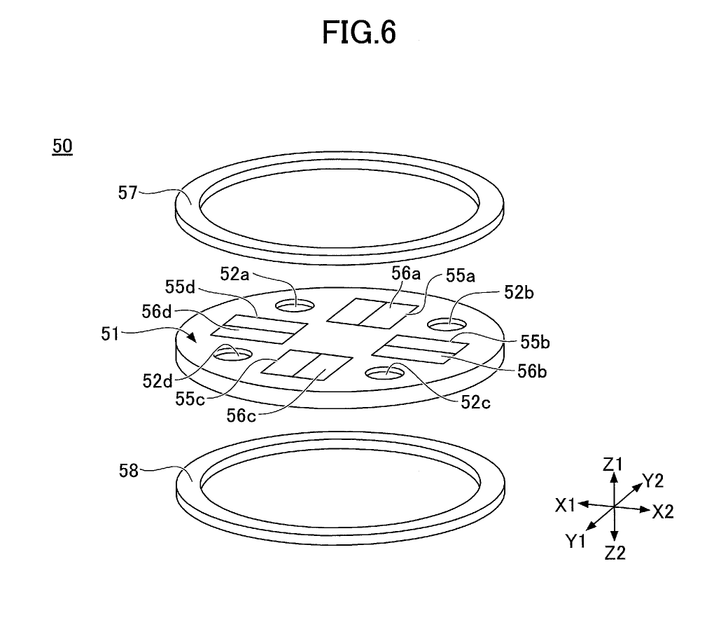

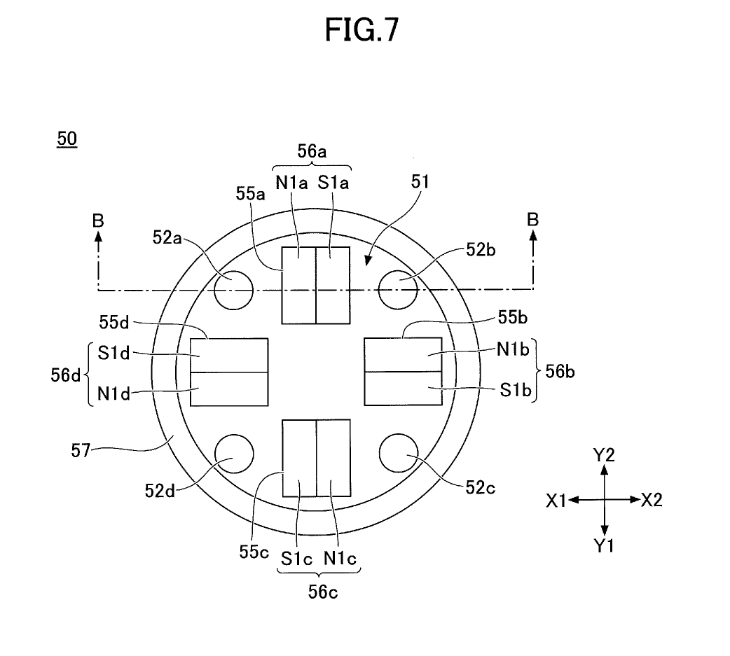

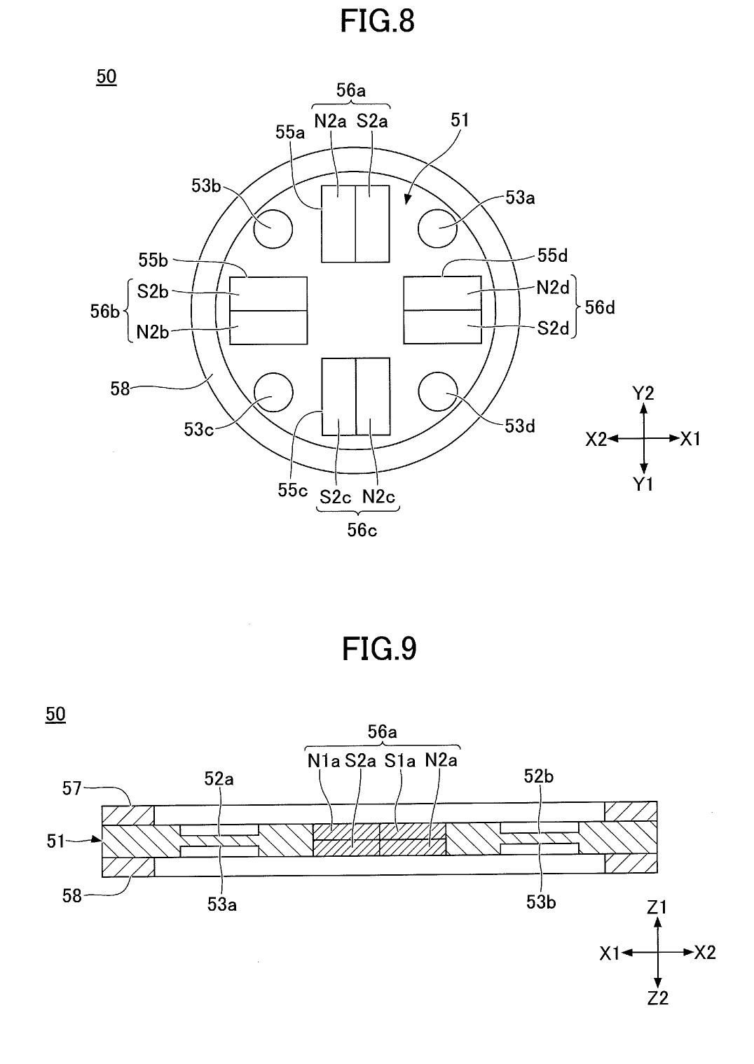

FIG. 6 is an exploded perspective view of the mover 50 according to the embodiment. FIG. 7 is a top view of the mover 50 according to the embodiment. FIG. 8 is a bottom view of the mover 50 according to the embodiment. FIG. 9 is a cross-sectional view of the mover 50 taken through B-B of FIG. 7.

As illustrated in FIG. 6 through FIG. 9, the mover 50 includes a substrate 51, a ring-shaped upper weight plate 57, and a ring-shaped lower weight plate 58.

The substrate 51 is formed of a non-magnetic material such as brass, tungsten, or austenitic stainless steel, and is formed in a disc shape. The substrate 51 has, for example a diameter of 17 mm and a thickness of 0.9 mm. Substrate upper recesses 52a through 52d, substrate lower recesses 53a through 53d, and through-holes 55a through 55d are formed on the substrate 51.

The substrate upper recesses 52a through 52d are each formed in a circular shape and are recessed from the upper surface of the substrate 51 in the Z2 direction. The substrate upper recesses 52a through 52d are located at equal distances from the center of the substrate 51 in the radial direction, and are arranged at equal intervals in the circumferential direction. The substrate upper recesses 52a through 52d may each have, for example, a diameter of 1.5 mm, and a depth of 0.3 mm from the upper surface of the substrate 51.

The substrate lower recesses 53a through 53d are each formed in a circular shape and are recessed from the lower surface of the substrate 51 in the Z1 direction. The substrate lower recesses 53a through 53d are located at equal distances from the center of the substrate 51 in the radial direction, and are arranged at equal intervals in the circumferential direction. Further, the substrate lower recesses 53a through 53d are formed at positions in correspondence with the positions of the substrate upper recesses 52a through 52d formed at the upper surface side of the substrate 51. The substrate lower recesses 53a through 53d may each have, for example, a diameter of 1.5 mm, and a depth of 0.3 mm from the lower surface of the substrate 51. The through-holes 55a through 55d pass through the substrate 51 and hold permanent magnets 56a through 56d. The through-holes 55a through 55d are located at equal distances from the center of the substrate 51 in the radial direction, and are arranged at equal intervals in the circumferential direction. Further, the through-hole 55a and the through-hole 55c are arranged parallel to the Y1Y2 direction, and the through-hole 55b and the through-hole 55d are arranged parallel to the X1X2 direction. The substrate upper recesses 52a through 52d and the substrate lower recesses 53a through 53d are alternately arranged with the through-holes 55a through 55d in the circumferential direction of the substrate 51.

The through-holes 55c are each formed in a rectangular shape having longer sides of 4 mm and shorter sides of 3.5 mm. The through-hole 55a and the through-hole 55c are formed such that the longer sides are parallel to the Y1Y2 direction and the shorter sides are parallel to the X1X2 direction. Also, the through-hole 55b and the through-hole 55d are formed such that the longer sides are parallel to the X1X2 direction and the shorter sides are parallel to the Y1Y2 direction.

The permanent magnets 56a through 56d are placed in through-holes 55a through 55d so as to be embedded in the substrate 51. Each of the permanent magnets 56a through 56d is a neodymium magnet, for example, and is formed in a rectangular shape of the same size as the through-holes 55a through 55d of the substrate 51. For example, the permanent magnets 56a through 56d are placed in the through-holes 55a through 55d, and are bonded to the substrate 51 with an adhesive.

Each of the permanent magnets 56a through 56d has four poles of a first N-pole N1, a first S-pole S1, a second N-pole N2, and a second S-pole S2. It is noted that each of the permanent magnets 56a through 56d may be formed of two magnets with two poles. The permanent magnets 56a through 56d are provided such that the poles each extend from the center of the substrate 51 in the radial direction, and the N-poles and the S-poles are alternately arranged in the circumferential direction of the substrate 51. The permanent magnet 56a and the permanent magnet 56c are embedded in the substrate such that a magnetization direction is parallel to the X1X2 direction at the lower surface side and the upper surface side of the substrate 51. The permanent magnet 56b and the permanent magnet 56d are embedded in the substrate 51 such that a magnetization direction is parallel to the Y1Y2 direction at the lower surface side and the upper surface side of the substrate 51.

Each of the upper weight plate 57 and the lower weight plate 58 are formed of a non-magnetic material such as brass, tungsten, or austenitic stainless steel, and are formed in a circular shape. An outer diameter of the upper weight plate 57 and of the lower weight plate 58 is the same as an outer diameter of the substrate 51. Further, the upper weight plate 57 and the lower weight plate 58 each have an inner diameter that allows the upper and lower weight plates to not overlap the substrate upper recesses 52a through 52d, the substrate lower recesses 53a through 53d, and the permanent magnets 56a through 56d, when the upper weight plate 57 and the lower weight plate 58 are disposed on the substrate 51 in such a manner that the outer peripheries of the upper weight plate 57 and the lower weight plate 58 conform to the outer periphery of the substrate 51.

By disposing the upper weight plate 57 and the lower weight plate 58 on the substrate 51, the mover 50 obtains sufficient weight to provide a vibration sensation to a user of an electronic device in which the vibration actuator 100 is installed. For example, the weight of the mover 50 may be increased by increasing the thickness of a peripheral portion of the substrate 51. However, due to the complicated shape of the substrate 51, there may be a possibility that workability of the substrate 51 would decrease and thus manufacturing costs would increase. Conversely, the mover 50 according to the present embodiment has a simple configuration in which the upper weight plate 57 and the lower weight plate 58 are disposed on the substrate 51, allowing the weight to be increased without resulting in an increase in manufacturing costs.

Further, the upper weight plate 57 and the lower weight plate 58 are disposed on the substrate 51 without overlapping the substrate upper recesses 52a through 52d, the substrate lower recesses 53a through 53d, and the permanent magnets 56a through 56d. Thus, it is possible to increase the weight of the mover 50 without hindering the movement of the mover 50. Also, spaces in the upper case 10 and in the lower case 20 are effectively used to dispose the upper weight plate 57 and the lower weight plate on the both surfaces of the substrate 51. Thus, it is possible to sufficiently secure the weight of the mover 50.

Further, the substrate 51, the upper weight plate 57, and the lower weight plate 58 may be formed of the same material. Alternatively, in order to increase the weight of the mover 50, the upper weight plate 57 and the lower weight plate 58 may be formed of a material having a specific gravity higher than the specific gravity of the material of the substrate 51. For example, when the substrate 51 is formed of brass in order to increase the workability of the substrate, the upper weight plate 57 and the lower weight plate 58 are formed of tungsten, which has a specific gravity higher than that of brass, even though the workability of the plates decreases. In this manner, by forming the upper weight plate 57 and the lower weight plate 58 as separate components from the substrate 51, different materials can be used depending on the desired function of each of the components. As a result, it is possible to reduce manufacturing costs while improving the degree of design freedom.

Next, a supporting structure and movement of the mover 50 in the vibration actuator 100 will be described.

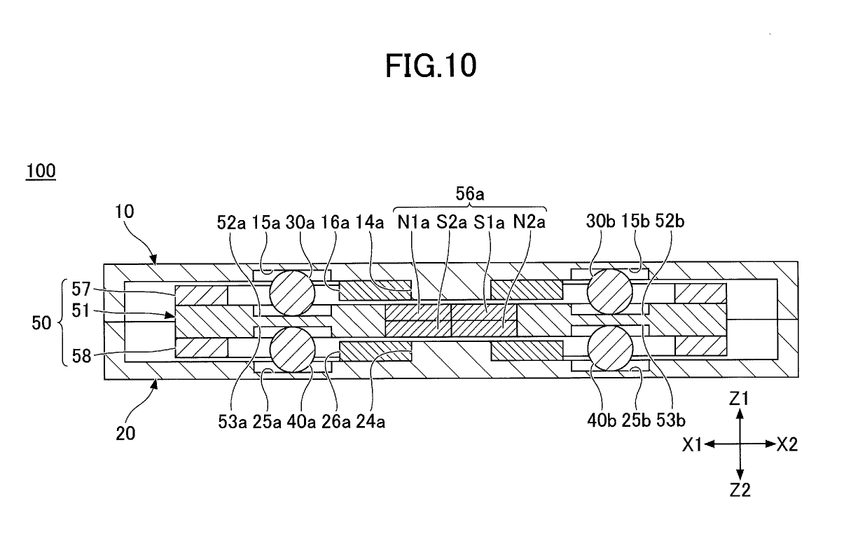

FIG. 10 is across-sectional view of the mover 50 taken through A-A of FIG. 2. In FIG. 10, an XZ cross-sectional view passing through the upper core 14a and the lower core 24a is illustrated.

As illustrated in FIG. 10, in the vibration actuator 100, the upper case 10 and the lower case 20 are bonded to each other, such that an upper case recess 15 and a lower case recess 25 face each other in the Z1Z2 direction. The mover 50 is housed between the upper case 10 and the lower case 20, such that a substrate upper recess 52 and the upper case recess 15 face each other in the Z1Z2 direction while also a substrate lower recess 53 and a lower case recess 25 face each other in the Z1Z2 direction. Further, the mover 50 is movably supported by an upper ball 30 provided between the substrate upper recess 52 and the upper case recess 15 and by a lower ball 40 provided between the substrate lower recess 53 and the lower case recess 25.

The upper ball 30 and the lower ball 40 are support members that are formed of, for example, stainless steel or ceramic, and that movably support the mover 50 while being rotated. The upper ball 30 and the lower ball 40 each have a diameter of 1.2 mm, for example.

An upper portion of the upper ball 30 is accommodated in the upper case recess 15, and makes contact with the upper case 10, and a lower portion of the upper ball 30 is accommodated in the substrate upper recess 52 and makes contact with the substrate 51. The upper ball 30 forms a predetermined space between the upper case 10 and the mover 50. Also, the upper ball 30 is rotatably provided between the upper case recess 15 and the substrate upper recess 52, and movably supports the mover 50 from the upper surface side of the substrate 51.

An upper portion of the lower ball 40 is accommodated in the substrate lower recess 53, and makes contact with the substrate 51, and a lower portion of the lower ball 40 is accommodated in the lower case recess 25 and makes contact with the lower case 20. The lower ball 40 forms a predetermined space between the lower case 20 and the mover 50. Also, the lower ball 40 is rotatably provided between the lower case recess 25 and the substrate lower recess 53, and movably supports the mover 50 from the lower surface side of the substrate 51.

The mover 50 is supported by the rotatably provided upper ball 30 and lower ball 40, such that the mover 50 is movable in a direction orthogonal to the Z1Z2 direction. Further, the mover 50 is supported by the upper ball 30 and the lower ball 40, such that the mover 50 is rotatable in a given direction around a rotation axis that is parallel to the Z1Z2 direction.

It is noted that configurations such as the number and arrangement of upper balls 30 and lower balls 40 are not limited to the configuration illustrated in the present embodiment, as long as the mover 50 can be movably supported.

When a current is not applied to an upper coil 16 and a lower coil 26, the mover 50 is supported at a balanced position under magnetic force acting between the permanent magnet 56 and an upper core 14 and a lower core 24. In the present embodiment, the mover 50 is supported at a position where the center of the permanent magnet 56 approximately coincides with the center of the upper core 14 and of the lower core 24 when viewed from the top (hereinafter referred to as a “center position”). At the center position, the center of the upper case 10 and of the lower case 20 coincides with the center of the substrate 51.

When the mover 50 is supported at the center position and a current is applied to the upper coil 16 and to the lower coil 26, magnetic force acts between the permanent magnet 56 and the upper core 14 and the lower core 24, which are each excited, thereby causing the mover 50 to move.

For example, in the state illustrated in FIG. 10, upon the application of a current to the upper coil 16a in a direction such that the lower end of the upper core 14a becomes the N-pole, a first S-pole S1a of the permanent magnet 56a is attracted to the upper core 14a. Also, upon the application of a current to the lower coil 26a in a direction such that the upper end of the lower core 24a becomes the S-pole, a second N-pole N2a of the permanent magnet 56a is attracted to the lower core 24a. In this way, magnetic force generated by applying a current to the upper coil 16a and to the lower coil 26a generates a driving force on the permanent magnet 56a so as to move the mover 50 in the X1 direction.

Further, for example, in the state illustrated in FIG. 10, upon the application of a current to the upper coil 16a in a direction such that the lower end of the upper core 14a becomes the S-pole, a first N-pole N1a of the permanent magnet 56a is attracted to the upper core 14a. Also, upon the application of a current to the lower coil 26a in a direction such that the upper end of the lower core 24a becomes the N-pole, a second S-pole S2a of the permanent magnet 56a is attracted to the lower core 24a. In this way, magnetic force generated by applying a current to the upper coil 16a and to the lower coil 26a generates a driving force on the permanent magnet 56a so as to move the mover 50 in the X2 direction.

As described above, magnetic force generated by applying a current to the upper coil 16a and to the lower coil 26a generates a driving force on the permanent magnet 56a so as to move the mover 50 in the X1 direction or in the X2 direction. Further, by changing the amount of the current applied to the upper coil 16a and to the lower coil 26a, the amount of movement of the mover 50 can be changed.

Similarly, magnetic force generated by applying a current to the upper coil 16c and to the lower coil 26c generates a driving force on the permanent magnet 56c so as to move the mover 50 in the X1 direction or in the X2 direction. Further, magnetic force generated by applying currents to the upper coils 16b and 16d and the lower coils 26b and 26d generate driving forces on the permanent magnets 56b and 56d so as to move the mover 50 in the Y1 direction or in the Y2 direction.

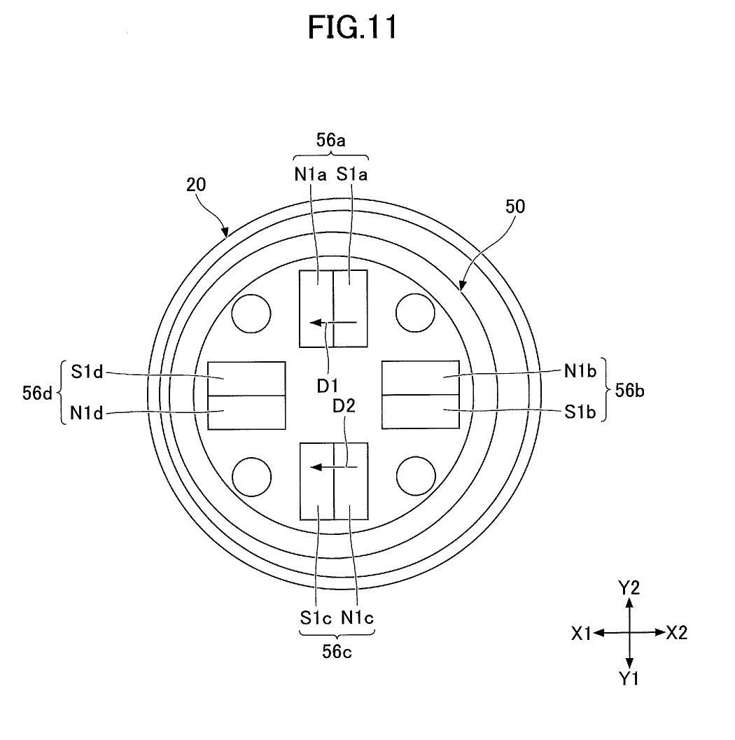

FIGS. 11 through 13 are diagrams illustrating movement of the mover 50. FIGS. 11 through 13 illustrate top views of the vibration actuator 100, where the upper case 10 and the upper balls 30a through 30d are not illustrated.

FIG. 11 is a diagram illustrating an example in which the mover 50 is moved in the X1 direction.

In order to move the mover 50 in the X1 direction, a current is applied to the upper coil 16a and to the lower coil 26a so as to generate a driving force on the permanent magnet 56a in the direction indicated by an arrow D1. Also, a current is applied to the upper coil 16c and to the lower coil 26c so as to generate a driving force on the permanent magnet 56c in the direction indicated by an arrow D2. Accordingly, by generating driving forces on the permanent magnet 56a and the permanent magnet 56c in the direction indicated by the arrows D1 and D2, it is possible to move the mover 50 from the center position in the X1 direction, as illustrated in FIG. 11.

Further, by applying a current in an opposite direction so as to generate driving forces on the permanent magnet 56a and the permanent magnet 56c in a direction opposite to the direction indicated by the arrows D1 and D2, it is possible to move the mover 50 from the center position in the X2 direction.

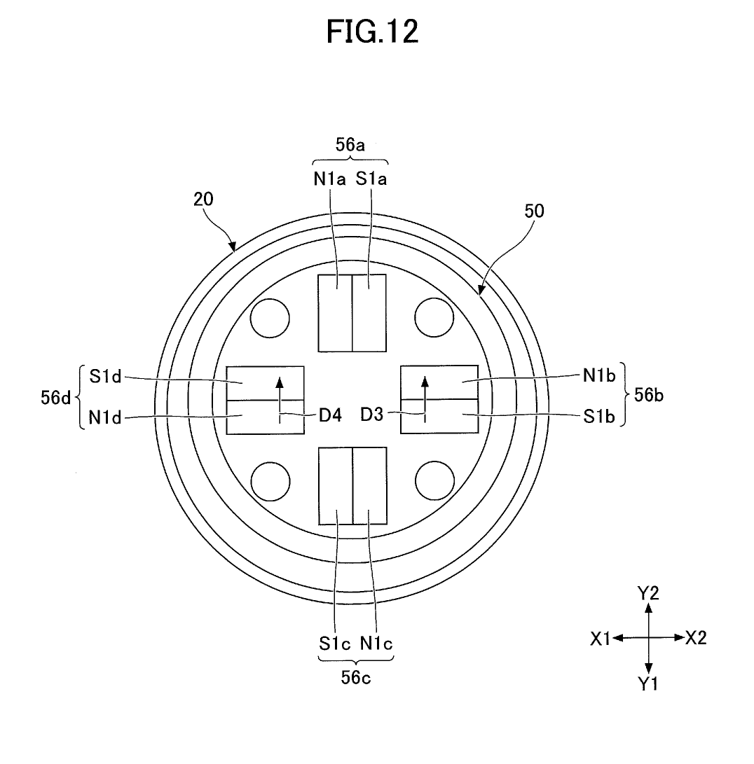

FIG. 12 is a diagram illustrating an example in which the mover 50 is moved in the Y2 direction.

In order to move the mover 50 in the Y2 direction, a current is applied to the upper coil 16b and the lower coil 26b so as to generate a driving force on the permanent magnet 56b in the direction indicated by an arrow D3. Also, a current is applied to the upper coil 16d and the lower coil 26d so as to generate a driving force on the permanent magnet 56d in the direction indicated by an arrow D4. In this way, by generating driving forces on the permanent magnet 56b and the permanent magnet 56d in the direction indicated by the arrows D3 and D4, the mover 50 moves from the center position in the Y2 direction, as illustrated in FIG. 12.

Further, when currents in an opposite direction are applied such that driving forces are generated on the permanent magnet 56b and the permanent magnet 56d in a direction opposite to the direction indicated by the arrows D3 and D4, the mover 50 moves from the center position in the Y1 direction.

In the vibration actuator 100 according to the present embodiment, by generating driving forces on the permanent magnet 56a and the permanent magnet 56c whose magnetization direction is parallel to the X1X2 direction, the mover 50 can be moved in the X1 direction or in the X2 direction.

Further, an example in which the mover 50 moves in a direction parallel to the X1X2 direction or the Y1Y2 direction has been described; however, it is possible to cause the mover 50 to move in a direction oblique to the X1X2 direction and the Y1Y2 direction.

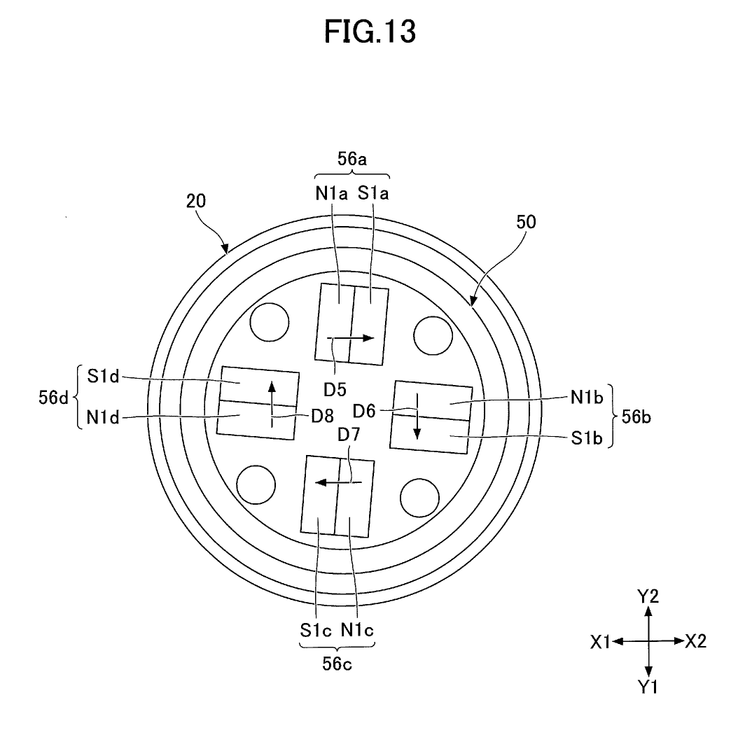

FIG. 13 is a diagram illustrating an example in which the mover 50 is rotated.

In order to rotate the mover 50 in a clockwise direction when viewed from the top, a current is applied to the upper coil 16a and the lower coil 26a so as to generate a driving force on the permanent magnet 56a in the direction indicated by an arrow D5. Also, currents are applied to the upper coils 16b through 16d and the lower coils 26b through 26d so as to generate a driving force on the permanent magnet 56b in the direction indicated by an arrow D6, a driving force on the permanent magnet 56c in the direction indicated by an arrow D7, and a driving force on the permanent magnet 56d in the direction indicated by an arrow D8. In this way, by generating driving forces on the permanent magnets 56a through 56d in the respective directions indicated by the arrows D5 through D8, the mover 50 can be rotated in the clockwise direction when viewed from the top.

Further, for example, by applying alternating currents to the coils, the mover 50 can vibrate in a given direction in a period of several Hz to 500 kHz. For example, the mover 50 can be vibrated in such a manner that the amount of displacement increases in a direction in accordance with a user's operation of an electronic device in which the vibration actuator 100 is installed.

The mover 50 according to the present embodiment is provided such that the magnetization direction of the permanent magnet 56a and of the permanent magnet 56c becomes orthogonal to the magnetization direction of the permanent magnet 56b and of the permanent magnet 56d. Accordingly, it is possible to generate driving forces on the permanent magnet 56a and the permanent magnet 56c in a direction orthogonal to a direction of driving forces generated on the permanent magnet 56b and the permanent magnet 56d.

Therefore, driving forces generated on the permanent magnet 56a and the permanent magnet 56c and driving forces generated on the permanent magnet 56b and the permanent magnet 56d can cause the mover to move from the center position in a given direction orthogonal to the Z1Z2 direction. Further, the mover 50 can be rotated in a given direction around the rotation axis that is parallel to the Z1Z2 direction.

It is noted that the number and arrangement of permanent magnets 56 of the mover 50 are not limited to those illustrated in the present embodiment. An upper core 14, an upper coil 16, a lower core 24, and a lower coil 26 are provided at positions in correspondence with the position of a corresponding permanent magnet 56 embedded in the substrate 51 of the mover 50. For example, when the mover 50 vibrates in one predetermined direction, the number of permanent magnets 56 used for the mover 50 may be one.

In the vibration actuator 100 according to the present embodiment, the upper coil 16 is attached the upper core 14, and the lower coil 26 is attached to the lower core 24. Accordingly, greater magnetic force can be generated by providing a coil around a core that is formed of a magnetic material, as compared to when an air-core coil without a core is used. Thus, in the vibration actuator 100 according to the present embodiment, it is possible to provide sufficient driving forces to vibrate the mover 50, without increasing the number of coil turns or increasing the amount of current flowing through the coil.

Further, the upper case 10 and the lower case 20 formed of magnetic materials according to the present embodiment function as back yokes. Thus, the upper case 10 functioning as the back yoke provides a magnetic path for magnetic force generated in the upper core 14 and the upper coil 16, thereby improving the magnetic efficiency. Similarly, the lower case 20 functioning as the back yoke provides a magnetic path for magnetic force generated in the lower core 24 and the lower coil 26, thereby improving the magnetic efficiency.

Accordingly, driving forces required to vibrate the mover 50 can be efficiently obtained.

At the upper surface side of the substrate 51, a movable range of the mover 50 is limited by an upper ball 30, an upper case recess 15, and a substrate upper recess 52. Also, at the lower surface side of the substrate 51, a movable range of the mover 50 is limited by a lower ball 40, a lower case recess 25, and a substrate lower recess 53.

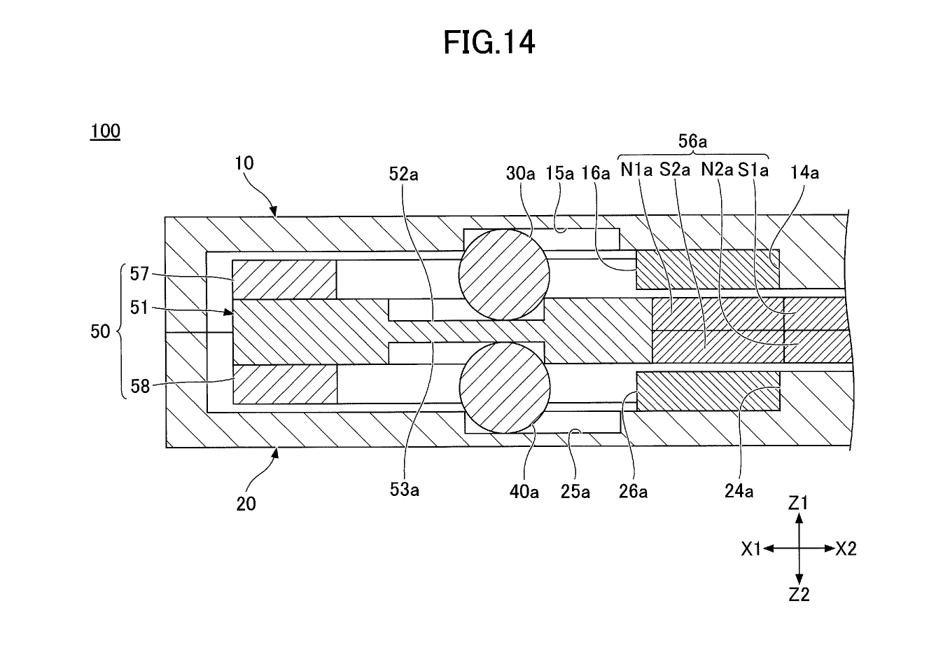

FIG. 14 is a diagram illustrating a movable range of the mover 50 according to the embodiment.

As illustrated in FIG. 14, when the mover 50 is moved in the X1 direction, the upper ball 30 makes contact with both the side wall surface of the substrate upper recess 52 and the side wall surface of the substrate lower recess 15. In this state, the mover 50 is unable to move in the X1 direction any further. Likewise, in a state where the lower ball 40 makes contact with both the side wall surface of the substrate lower recess 53 and the side wall surface of the lower case recess 25, the mover 50 is unable to move in the X1 direction any further. As described, the movement of the mover 50 in the X1 direction becomes restricted when the upper ball 30 makes contact with both the side wall surface of the substrate upper recess 52 and the side wall surface of the upper case recess 15 or when the lower ball 40 makes contact with both the side wall surface of the substrate lower recess 53 and the side wall surface of the lower case recess 25. In FIG. 14, an example of restriction of the movement of the mover 50 in the X1 direction has been described; however, the present embodiment is not limited to this example, and the movement of the mover 50 in any direction becomes restricted in a similar manner.

As described above, the upper case recess 15 and the substrate upper recess 52 each accommodate at least a part of the upper ball 30, and each function as a stopper for limiting the movable range of the mover 50 at the upper surface side of the substrate 51. Also, the lower case recess 25 and the substrate lower recess 53 each accommodate at least a part of the lower ball 40, and each function as a stopper for liming the movable range of the mover 50 at the lower surface side of the substrate 51.

The movable range of the mover 50 is determined by the size of the upper case recess 15 and of the upper case recess 15 and the diameter of the upper ball 30 and of the lower ball 40. The movable range of the mover 50 is set within a range in which magnetic force of the permanent magnets 56 acts on the upper core 14 and the lower core 24. Further, the upper case 10, the lower case 20, and the mover 50 have sizes so as not to collide with each other when the mover 50 is moved in the movable range.

With the above-described configuration, if the vibration actuator 100 is subjected to an impact, causing the mover 50 to be moved from the center position, the mover 50 is prevented from colliding with the upper case 10 and the lower case 20. Further, magnetic force acting between the permanent magnets 56 and the upper core 14 and the lower core allows the mover 50 to return to the center position. Accordingly, even if the vibration actuator 100 is subjected to an impact, it is possible to maintain the position control of the mover 50, while also minimizing damage to the mover 50, the upper case 10, and the lower case 20.

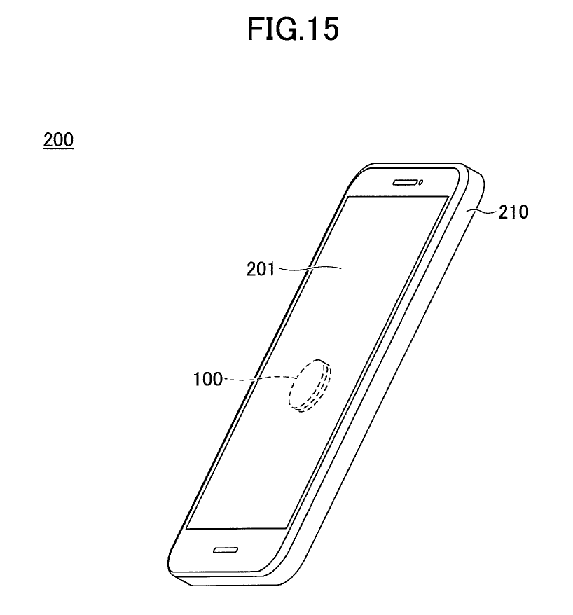

FIG. 15 is a perspective view of a mobile phone 200 according to the present embodiment. The mobile phone 200 is what is termed as a smartphone, and includes an operation screen 201 and a case 210. Also, the mobile phone 200 includes the vibration actuator 100 inside the case 210.

In the vibration actuator 100, the upper coil 16 and the lower coil 26 are connected to a control circuit (not illustrated). In the vibration actuator 100, an alternating current is applied from the control circuit to the upper coil 16 and the lower coil 26, causing the mover 50 to vibrate. The direction or the magnitude of vibration of the mover 50 is set in accordance with a user's operation on the operation screen 201. An alternating current required to cause the mover 50 to vibrate is applied from the control circuit to upper coil 16 and the lower coil 26.

Although the mobile phone 200 is illustrated as an electronic device in which the vibration actuator 100 is installed, the electronic device in which the vibration actuator 100 is installed is not limited thereto. For example, the vibration actuator 100 may be mounted on an electronic device such as personal digital assistant including a tablet personal computer, a game console controller, or other various types of wearable devices.

As described above, according to the mover 50 of the present embodiment, the upper weight plate 57 and the lower weight plate 58 are disposed on the substrate 51. Accordingly, even when the mover 50 is made thinner, the mover 50 can have sufficient weight to transmit vibrations. Therefore, by causing the mover 50 of the vibration actuator 100 to vibrate, a vibration sensation can be sufficiently provided to a user of an electronic device in which the vibration actuator 100 is installed.

In the present embodiment, the mover 50 is housed between the upper case 10 and the lower case 20; however, the upper case 10 and the lower case 20 are not limited to this configuration. The upper case 10 and the lower case 20 that include an upper coil 16 and a lower coil 26 are formed as a stator of the mover 50 that includes a permanent magnet 56. For example, side surfaces of the upper case 10 and the lower case 20 may have openings, or one of the cases may be integrated with a housing or an inner substrate of an electronic device.

Next, variations of the mover 50 according to the embodiment will be described.

(First Variation)

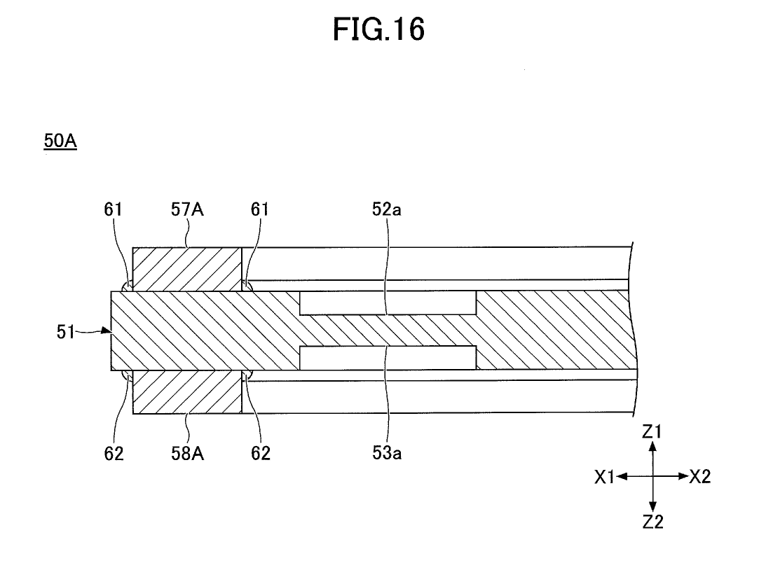

FIG. 16 is a diagram illustrating a first variation of the mover 50 according to the embodiment. In FIG. 16, a partially enlarged cross-sectional view of a mover 50A according to the first variation is illustrated.

In the mover 50A according to the first variation, an upper weight plate 57A and a lower weight plate 58A each has a smaller outer diameter than the outer diameter of the substrate 51. Also, the upper weight plate 57A and the lower weight plate 58A are disposed at positions that are shifted inward from the outer periphery of the substrate 51. An outer side surface (outer peripheral surface) and an inner side surface (inner peripheral surface) of the upper weight plate 57A are welded to the upper surface of the substrate 51 by welds 61. Also, an outer side surface (outer peripheral surface) and an inner side surface (inner peripheral surface) of the lower weight plate 58A are welded to the lower surface of the substrate 51 by welds 62.

The upper weight plate 57A and the lower weight plate 58A are disposed at positions that are shifted inward from the outer periphery of the substrate 51. Accordingly, even if the mover 50 is moved by an external impact and collides with side walls of the upper case 10 and the lower case 20, the upper weight plate 57A and the lower weight plate 58A would not directly collide with the side walls of the upper case 10 and the lower case 20. Thus, welded portions would not be readily damaged. Further, if the upper weight plate 57A and the lower weight plate 58A were to be formed so as to have the same diameter as the diameter of the substrate 51, the outer diameter of the mover 50 would increase when the outer peripheral surfaces are welded to each other. In the mover 50A according to the first variation, when the upper weight plate 57A and the lower weight plate 58A are welded to the substrate 51 by, for example, laser welding, welding from the sides of the substrate 51 are not required. The upper weight plate 57A and the lower weight plate 58A can be welded to the substrate 51 only from the upper surface side and the lower surface side of the substrate 51, without increasing the outer diameter of the mover 50 due to welded portions.

(Second Variation)

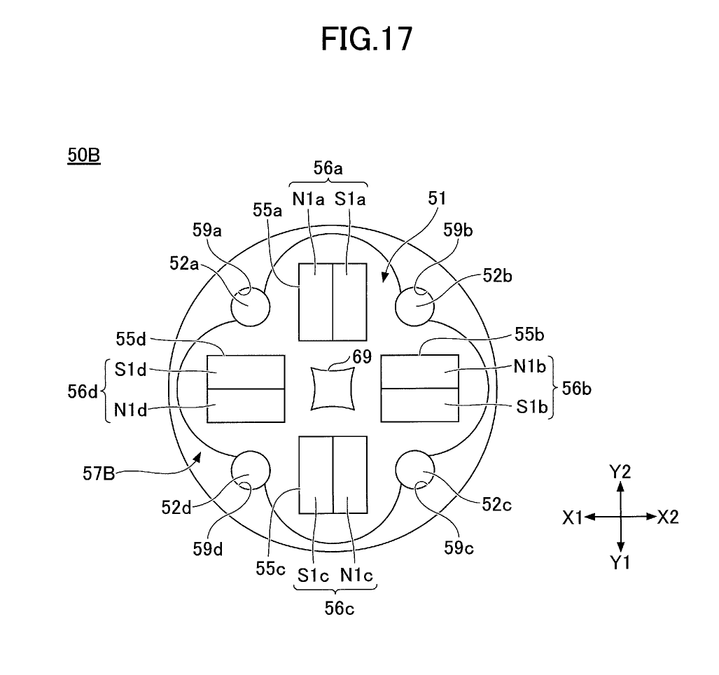

FIG. 17 is a diagram illustrating a second variation of the mover 50 according to the embodiment. In FIG. 17, a top view of mover 50B according to the second variation is illustrated.

On the inner peripheral surface of the upper weight plate 57B of the mover 50B according to the second variation, a stopper 59 that is curved in a semicircular shape conforming to an outer periphery of a corresponding substrate upper recess 52 is formed. The upper weight plate 57B is bonded to the substrate 51 after the stopper 59 is positioned so as to conform to the shape of the corresponding substrate upper recess 52.

In this way, the stopper 59 surrounding at least a part of the substrate upper recess 52 is formed. Accordingly, even if an upper ball 30, an upper case recess 15, and a lower case recess 25 are worn and a gap is created due to the vibration actuator 100 used for a long period of time, the upper ball 30 can be prevented from moving up onto the upper surface of the substrate 51. For example, even if the vibration actuator 100 is subjected to an impact and the mover 50 is moved, the stopper 59 of the upper weight plate 57B makes contact with the upper ball 30. Thus, it is possible to reduce the likelihood of the upper ball 30 moving up onto the upper surface of the substrate 51 and the mover 50 moving out of the movable range.

Accordingly, the stopper 59 formed so as to conform to the shape of the substrate upper recess 52 of the upper weight plate 57B can prevent the upper ball 30 from moving out of the substrate upper recess 52 and also prevent the mover 50 from moving beyond the movable range when the vibration actuator 100 is subjected to an impact.

Further, the mover 50B includes an upper center weight plate 69 disposed at a center portion of the substrate 51. By providing the upper center weight plate 69 at a position that does not overlap the permanent magnet 56 and the substrate upper recess 52, the mover 50B can be made heavier. By making the mover 50B heavier, a vibration sensation can be sufficiently provided to a user of an electronic device in which the vibration actuator 100 is installed.

The stopper 59 of the upper weight plate 57B may be formed so as to surround at least a part of the substrate upper recess 52, or may be formed so as to surround the entire periphery of the substrate upper recess 52. Further, the shape of upper center weight plate 69 is not limited to the shape illustrated in FIG. 17, as long as the upper center weight plate 69 does not overlap the permanent magnet 56 and the substrate upper recess 52, and does not make contact with the upper core 14.

Further, a lower weight plate having the same shape as the upper weight plate 57B and a lower center weight plate having the same shape as the upper center weight plate 69 may be disposed on the lower surface of the mover 50B. The lower weight plate may also have a stopper. The stopper of the lower weight plate prevents the lower ball 40 from moving out of the substrate lower recess 53 and the mover 50B from moving beyond the movable range at the lower surface side of the substrate 51. Further, the lower center weight plate makes the mover 50B heavier. Thus, it is possible to increase a vibration sensation provided to the user of an electronic device in which the vibration actuator 100 is installed.

(Third Variation)

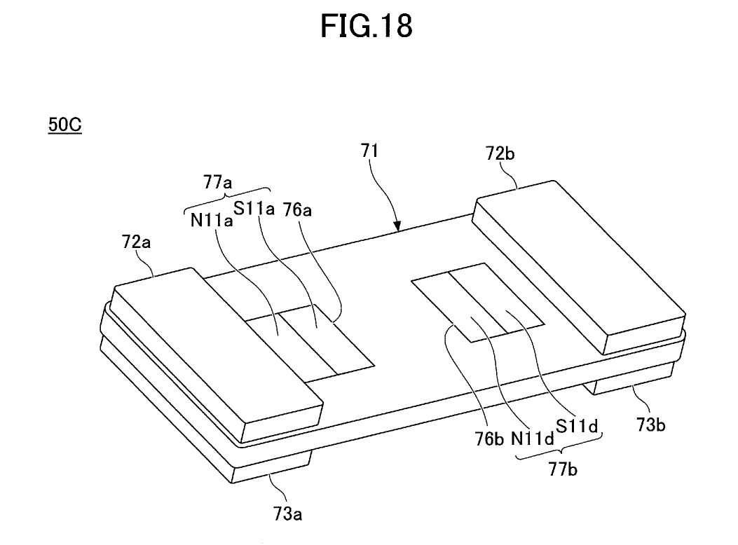

FIG. 18 is a diagram illustrating a third variation of the mover 50 according to the embodiment. In FIG. 18, a perspective view of a mover 50C according to the third variation is illustrated.

The mover 50C according to the third variation includes a substrate 71, upper weight plates 72a and 72b, and lower weight plates 73a and 73b.

The substrate 71 is formed in a rectangular shape, and has two through-holes 76a and 76b. The through-holes 76a and 76b pass through the substrate 71 and hold permanent magnets 77a and 77b. The permanent magnets 77a and 77b are placed in the respective through-holes 76a and 76b, and are embedded in the substrate 71. For example, the permanent magnets 77a and 77b are placed in the respective through-holes 76a and 76b, and are bonded to the substrate 71 with an adhesive. Each of the permanent magnets 77a and 77b has an N-pole N11 and an S-pole S11 at the upper surface side of the substrate 71. At the lower surface of the substrate 71, the arrangement of an N-pole and an S-pole are reversed from the arrangement at the upper surface side of the substrate 71.

The upper weight plates 72a and 72b and the lower weight plates 73a and 73b are each formed in a rectangular shape, and are disposed at end portions of the substrate 71. Similar to the first variation, the upper weight plates 72a and 72b and the lower weight plates 73a and 73b are disposed at positions that are shifted inward from the outer periphery of the substrate 71. The side surfaces of the upper weight plates 72a and 72b, which are parallel to the longitudinal direction of the substrate 71, are welded to the upper surface of the substrate 71 by welds (not illustrated). Also, side surfaces of the lower weight plate 73, which are parallel to the longitudinal direction of the substrate 71, are welded to the lower surface of the substrate 71 by welds (not illustrated)

Similar to the above-described embodiment, the mover 50C is housed between cases, and is movably supported by a plurality of balls from the both surfaces. The cases that house the substrate 71 and the mover 50C may have recesses that accommodate at least a part of each of the balls and also limit the movable range of the mover 50C. The cases that house the substrate 71 and the mover 50C are provided with cores and coils at positions in correspondence with the position of a corresponding permanent magnet 77. When a current flows through the coils, the coils are excited and magnetic force acts between the cores and the corresponding permanent magnet 77, causing the mover 50C to move.

As illustrated in the mover 50C of the third variation, the substrate 71 may be formed in a rectangular shape. Similar to the mover 50 of the above-described embodiment, the upper weight plates 72a and 72b and the lower weight plates 73a and 73b make the mover 50C heavier, thus increasing a vibration sensation provided to the user of an electronic device in which the vibration actuator 100 is installed.

The mover 50C may be supported by elastic members such as leaf springs, instead of the plurality of balls, so as to be movable in a longitudinal direction.

Although the movers, the vibration actuators, and the electronic devices according to the embodiments have been described, the present invention is not limited to these embodiments. Various variations and modifications may be made without departing from the scope of the present invention.

What is claimed is:

1. A mover for a vibration actuator, the mover comprising:
a substrate;
a permanent magnet that is embedded in the substrate; and
a weight plate disposed on the substrate.

2. The mover according to claim 1, wherein the weight plate is disposed on the substrate at a position that does not overlap the permanent magnet.

3. The mover according to claim 1, further comprising another weight plate,
wherein the weight plate is disposed on one surface of the substrate and said another weight plate is disposed on another surface of the substrate.

4. The mover according to claim 1, wherein the weight plate is formed of a first material and the substrate is formed of a second material, the first material having a specific gravity higher than a specific gravity of the second material.

5. The mover according to claim 1, wherein the weight plate is disposed at a position that is shifted inward from an outer periphery of the substrate.

6. The mover according to claim 1, wherein a side surface of the weight plate is welded to the substrate.

7. A vibration actuator comprising:
a mover according to claim 1;
a case that houses the mover;
a coil provided inside the case at a position in correspondence with a position of the permanent magnet; and
a support member configured to movably support the mover.

8. The vibration actuator according to claim 7, wherein the support member supports the mover such that the mover is movable in a direction parallel to one surface of the substrate.

9. The vibration actuator according to claim 7, wherein the support member rotatably supports the mover.

10. The vibration actuator according to claim 7, wherein the weight plate is disposed on the substrate at a position that does not overlap the permanent magnet.

11. The vibration actuator according to claim 7, further comprising another weight plate,
wherein the weight plate is disposed on one surface of the substrate and said another weight plate is disposed on another surface of the substrate.

12. The vibration actuator according to claim 7, wherein the weight plate is formed of a first material and the substrate is formed of a second material, the first material having a specific gravity higher than a specific gravity of the second material.

13. The vibration actuator according to claim 7, wherein the weight plate is disposed at a position that is shifted inward from an outer periphery of the substrate.

14. The vibration actuator according to claim 7, wherein a side surface of the weight plate is welded to the substrate.

15. An electronic device comprising the vibration actuator according to claim 7.
